(19) United States
(12) Patent Application Publication
(10) Pub. No.: US 2012/0043319 A1
(43) Pub. Date: Feb. 23, 2012

(54) HOUSING ASSEMBLY AND METHOD FOR MANUFACTURING SAME

(75) Inventors: XU-DONG LU, Shenzhen (CN); KUAN-HUNG CHEN, Shindian (TW); YAO WANG, Shenzhen (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 12/880,249

(22) Filed: Sep. 13, 2010

(30) Foreign Application Priority Data
Aug. 18, 2010 (CN) 201010256603.X

(51) Int. Cl. B65D 6/28; B32B 37/12; B29C 65/02; B32B 37/02

(52) U.S. Cl. 220/4.01; 156/293

(57) ABSTRACT

A housing assembly includes a first housing and a second housing adhered to the first housing. Protruding from the first housing or the second housing are one or more hot-melt posts, the other of the first housing and the second housing defines one or more hot-melt holes; each hot-melt post is hot-melted in one of the hot-melt holes.

### BACKGROUND

1. Technical Field

The disclosure generally relates to housing assemblies and methods for manufacturing the housing assemblies.

2. Description of Related Art

A typical way to assemble a metal element to a plastic housing is by adhesion of the metallic element to the plastic housing. However, typically, metallic elements can easily be separated from the plastic housing, as the adhering force created by typical adhesives is usually not strong enough.

Therefore, there is room for improvement within the art.

### BRIEF DESCRIPTION OF THE DRAWINGS

Many aspects of the exemplary housing assembly can be better understood with reference to the following drawings. These drawings are not necessarily drawn to scale, the emphasis instead being placed upon clearly illustrating the principles of the exemplary housing assembly and method manufacturing the housing assembly. Moreover, in the drawings like reference numerals designate corresponding parts throughout the several views. Wherever possible, the same reference numbers are used throughout the drawings to refer to the same or like elements of an embodiment.

FIG. 1 is a schematic and a partially exploded view of a housing assembly according to an exemplary embodiment.

FIG. 2 is another partially exploded view of the housing assembly of FIG. 1 showing another aspect.

FIG. 3 is an assembled view of the housing assembly shown in FIG. 1.

FIG. 4 is an assembled view of the housing assembly shown in FIG. 2.

### DETAILED DESCRIPTION

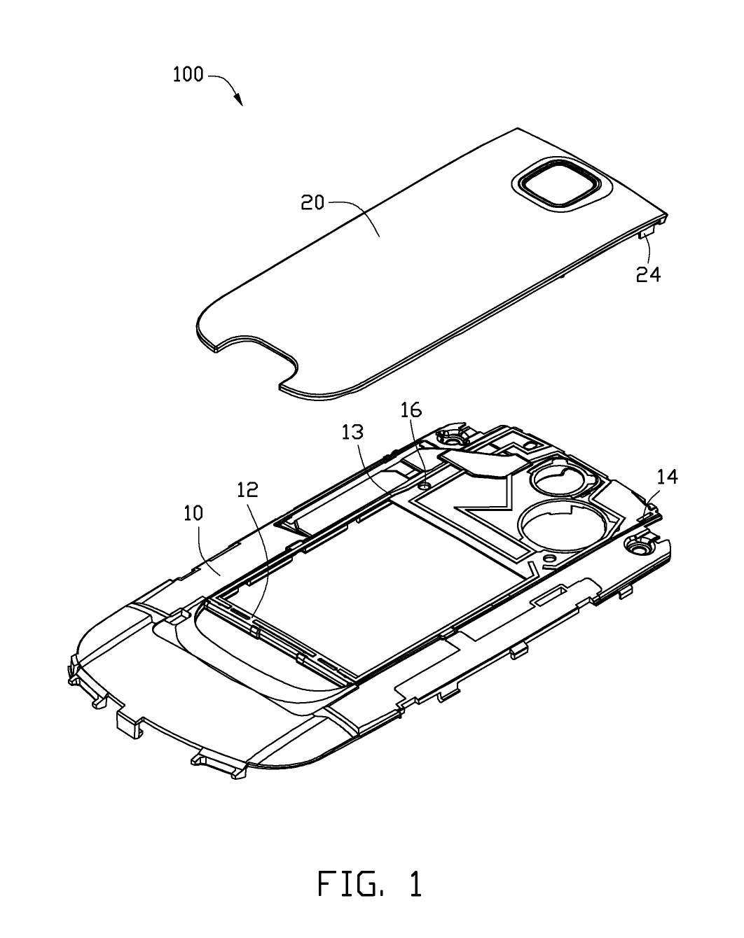

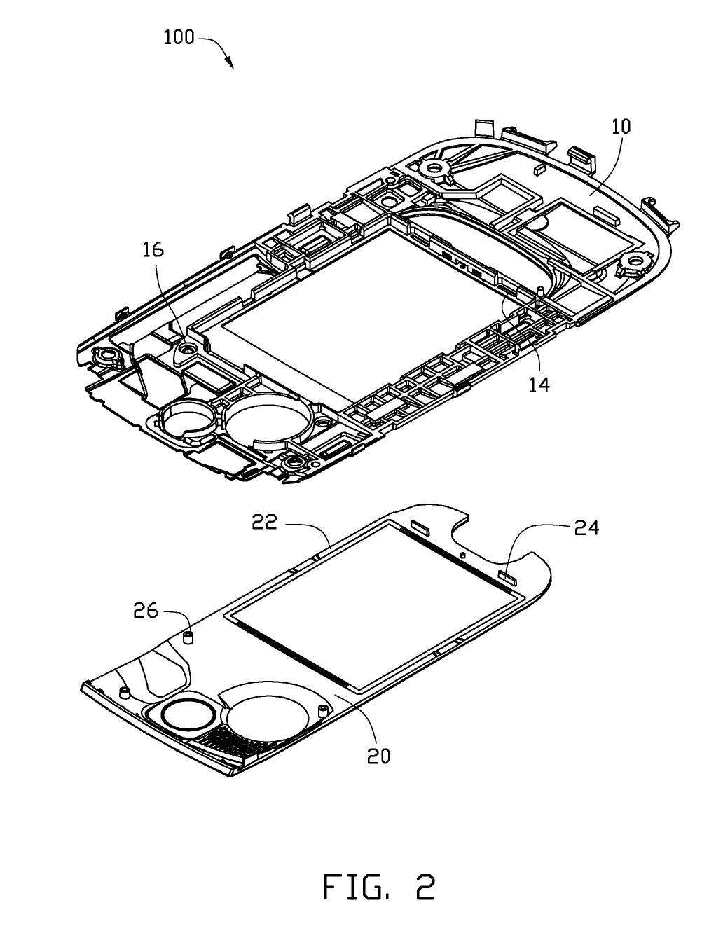

Referring to FIGS. 1 and 2, a housing assembly 100 includes a first housing 10 (e.g., a plastic housing) and a second housing 20 (e.g., a metallic housing). The first housing 10 includes a first attachable surface 12 and adhesive 13. The second housing 20 includes a second attachable surface 22 opposite to the first attachable surface 12. The second attaching surface 22 is adhered to the first attaching surface 12 by the adhesive 13.

The first housing 10 defines one or more first hot-melt holes 14 and one or more second hot-melt holes 16. In this exemplary embodiment, the number of the first hot-melt holes 14 and the number of the second hot-melt holes 16 are both two. The second housing 20 has one or more first hot-melt posts 24 for correspondingly protruding into the first hot-melt holes 14 and one or more second hot-melt posts 26 for correspondingly protruding into the second hot-melt holes 16. Each first hot-melt post 24 extends into and is hot-melted in one of the first hot-melt holes 14 and each second hot-melt post 26 extends into and is hot-melted in one of the second hot-melt holes 16 to retain the second housing 20 to the first housing 10.

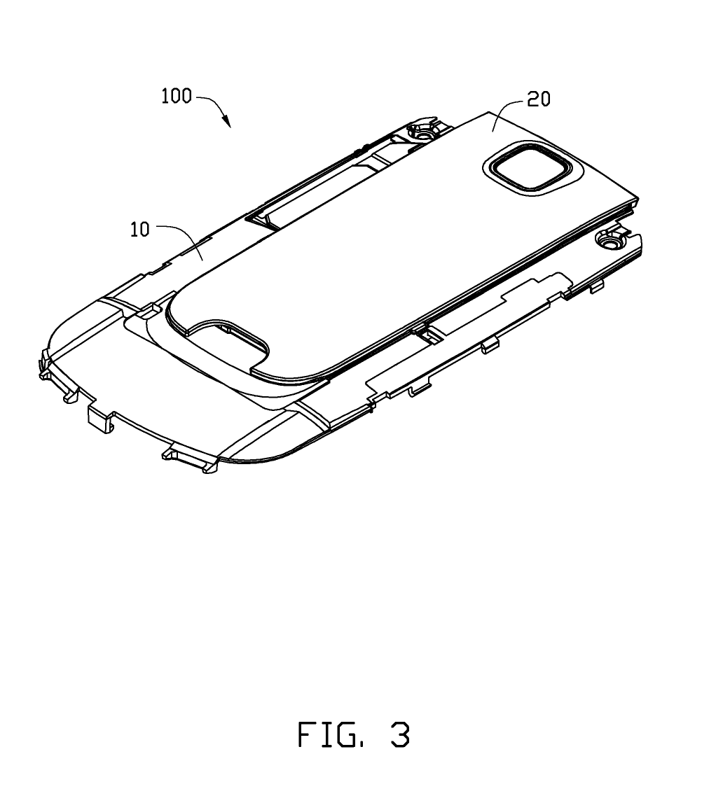

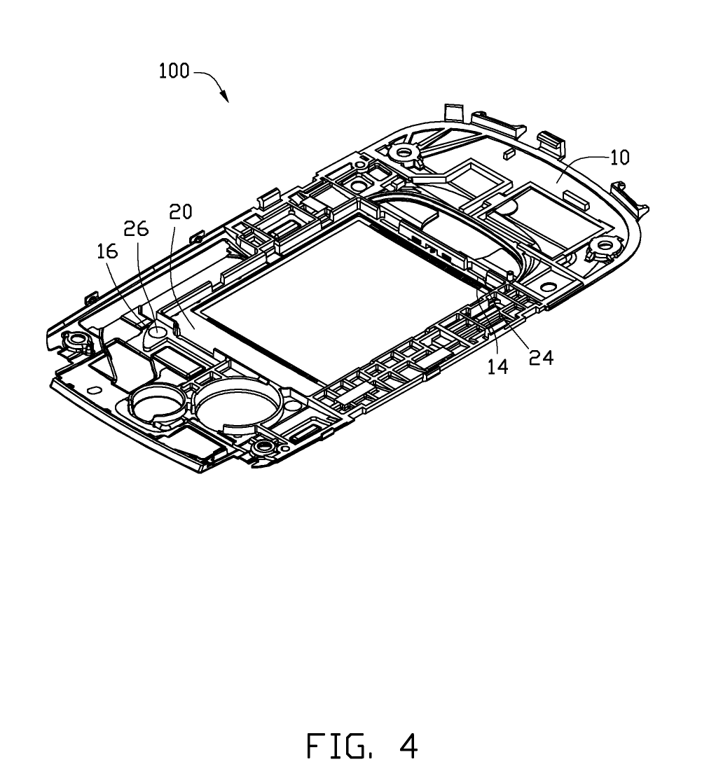

Referring to FIGS. 3 and 4, an exemplary method for manufacturing the housing assembly 100 includes the steps of:

the adhesive 13 is coated on the first attachable surface 12, the second attachable surface 22 is attached to the first attachable surface 12 so the second attachable surface 22 is adhered to the first attachable surface 12 with the adhesive 13. At this time, each first hot-melt post 24 extends into one of the first hot-melt holes 14 and each second hot-melt post 26 extends into one of the second hot-melt holes 16.

the first housing 10 and the second housing 20 are pressed together, with an exterior force, to improve the adhesive engagement of the first attachable surface 12 and the second attachable surface 22.

each first hot-melt post 24 is hot-melted in one of the first hot-melt holes 14 and each second hot-melt post 26 is hot-melted in one of the second hot-melt holes 16 to retain the second housing 20 to the first housing 10.

It is understood that the first hot-melt posts 24 and the second hot-melt posts 26 may be positioned on either the first housing 10 or the second housing 20, and the first hot-melt holes 14 and the second hot-melt holes 16 may be positioned on the element opposite the first hot-melt posts 24 and the second hot-melt posts 26.

It is to be understood, however, that even through numerous characteristics and advantages of the disclosure have been set forth in the foregoing description, together with details of the structure and function of the invention, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A housing assembly, comprising:
a first housing;
a second housing adhered to the first housing;
wherein one of the first housing and the second housing protrudes one or more hot-melt posts, the other of the first housing and the second housing defines one or more hot-melt holes; each hot-melt post is hot-melted in one of the hot-melt holes.

2. The housing of claim 1, wherein the hot-melt posts protrudes from the second housing, the hot-melt holes is defined in the first housing.

3. The housing of claim 1, wherein the first housing is plastic and the second housing is metallic.

4. A method for manufacturing a housing assembly, comprising the steps of:
providing a first housing and a second housing, wherein one of the first housing and the second hosing protrudes one or more hot-melt posts, the other of the first housing and the second housing defines one or more hot-melt holes;
adhering the first housing to the second housing by a adhesive with each hot-melt post extending into one of the hot-melt holes;
hot-melting each hot-melt post in one of the hot-melt holes.

5. The method of claim 4, wherein the hot-melt posts protrudes from the second housing, the hot-melt holes is defined in the first housing.

6. The method of claim 4, wherein the first housing is plastic and the second housing is metallic.
